(19) United States
(12) Patent Application Publication
(10) Pub. No.: US 2006/0085833 A1
(43) Pub. Date: Apr. 20, 2006

(54) Open cable digital broadcasting system having multiple DSG channel and method for acquiring home DSG channel in the same system

(76) Inventor: Hung-Rok Kwon, Suwon-si (KR)

Correspondence Address: Robert E. Bushnell, Suite 300, 1522 K Street, N.W., Washington, DC, 20005-1202, US

(21) Appl. No.: 11/219,816

(22) Filed: Sep. 7, 2005

(30) Foreign Application Priority Data
Oct. 18, 2004 (KR) 2004-83325

(51) Int. Cl. H04N 7/18; H04N 7/173

(52) U.S. Cl. 725/111; 725/105; 725/74; 725/80

(57) ABSTRACT

An open cable digital broadcasting system having a multiple data over cable service interface specifications set-top box gateway (DSG) channel and a method for acquiring a home DSG channel in a digital broadcasting system are provided. The method includes: a first step of searching for a downstream channel to a cable modem termination system (CMTS); a second step of determining whether an upstream channel to the CMTS is successful; a third step of converting to a DSG uni-directional downstream mode when the upstream channel search fails in the second step; a fourth step of determining whether DSG data is received from all servers; a fifth step of determining whether the channel is a multiple DSG channel when the DSG data is received in the fourth step; a sixth step of determining whether an upstream channel restoration function for the same channel is performed more than a preset or number of times or for more than a preset term when the DSG data is determined to be the multiple DSG channel in the fifth step; and a seventh step of performing a downstream channel restoration function when it is determined in the sixth step that the upstream channel restoration function for the same channel is performed more than the preset number of times or for more than the preset term. As a result, it is possible to search for a multiple DSG channel and to satisfy a provider service model request condition of an open cable digital broadcasting receiver.

### CLAIM OF PRIORITY

This application makes reference to, incorporates the same herein, and claims all benefits accruing under 35 U.S.C. §119 from an application for OPEN CABLE DIGITAL BROADCASTIIG SYSTEM HAVING MULTIPLE DSG CHANNEL AND METHOD FOR ACQUIRING HOME DSG CHANNEL IN THE SAME SYSTEM earlier filed in the Korean Intellectual Property Office on 18 Oct. 2004 and there duly assigned Serial No. 2004-83325.

### BACKGROUND OF THE INVENTION

1. Field of the Invention

The present invention relates to a method for acquiring a home Data Over Cable Service Interface Specifications (DOCSIS) Set-top box Gateway channel (or DSG channel) in a multiple DSG channel environment of an open cable digital broadcast receiver, and more particularly, to an open cable digital broadcasting system having a multiple DSG channel and method for acquiring a home DSG channel in the same system, in which an open cable digital broadcasting system having a multiple DSG channel is realized so that it is possible to support the multiple channel service of a service provider, and to provide a method for acquiring its own channel automatically when the multiple DSG channel is constructed.

2. Related Art

In general, Data Over Cable Service Interface Specifications (DOCSIS) is a standard interface of a cable modem, which is a device for processing input and output data or signals between a cable television operator and an individual, a business computer or a television set. DOCSIS is now known as “CableLabs Certified Cable Modem”. DOCSIS 1.0 was ratified by the International Telecommunication Union (ITU-TS) in March of 1998.

Cable modems conforming to DOCSIS are now being marketed. However, cable TV operators can support existing customers who have non-standard cable modems by adding the backwards-compatible DOCSIS card in order to handle their existing customers. As DOCSIS continues to evolve to new versions, users of the existing modems can upgrade DOCSIS to the newer versions by changing the program stored in the electrically erasable programmable read-only memory (EEPROM) of the cable modem. Cable modems supporting DOCSIS show a tendency to be integrated into set-top boxes for use with television sets, and must also support high definition television. The set-top box itself follows a standard known as OpenCable.

DOCSIS Set-top box Gateway (DSG) is a transmission standard for supporting digital television in the OpenCable environment. DSG is a digital cable television data transmission standard for performing bi-directional communication, and a DSG communication device performs bi-directional communication for transmission and reception with a service information server and with a conditional access server, a uni-directional function, and a restoration function of upstream and downstream channels, in addition to its function as a data modem through the existing DOCSIS.

Digital broadcasting includes digital terrestrial broadcasting, digital satellite broadcasting, and cable digital broadcasting according to the transmission medium. Currently, digital satellite broadcasting is activated all over the world, and it is being tested in the United States of America and in some countries in Europe.

Digital broadcasting highly efficiently compresses an amount of information of channel-specific programs on the basis of a Moving Picture Experts Group (MPEG) coding standard, and highly efficiently multiplexes and transmits programs corresponding to a plurality of channels on the basis of transmission medium-specific digital modulation schemes. Thus, digital broadcasting can broadcast several tens to hundreds of channels without using a large quantity of relays as in analog broadcasting.

A broadcasting system for conducting cable digital broadcasting is generally composed of: a head-end for transmitting a broadcasting-related digital signal, and for receiving and processing data uploaded from a subscriber; and a set-top box for receiving a digital signal transmitted from the head-end, and for converting the received digital signal into an analog signal to thereby recover the original audio and video signal.

The “head-end” is a main control center equipped with a technical device capable of receiving, producing and re-transmitting a program from a satellite or another place through a system network in a cable television system. “Set-top box” refers generally to a domestic communication terminal required in using multimedia communication services, including video-on-demand services.

With this configuration of the broadcasting system, each system operator (SO) produces programs, content and other data of the cable television, or the SO is supplied with them by producers so as to then transmit them to subscribers. In this manner, the subscribers can watch their desired broadcast programs after looking at the programs or other data transmitted by the SO.

Video and audio compression technology for use in cable digital broadcasting employs MPEG-2 as a standard in the world. Its modulation scheme employs one of the digital modulation schemes, i.e., a Quadrature Amplitude Modulation (QAM) scheme capable of changing the amplitude and phase of a carrier signal according to a digital data signal to be transmitted, which is suitable for higher-efficiency transmission of data within a limited transmission band. In particular, 64-state QAM digital frequency modulation technology is mainly used to transmit downstream data on a coaxial cable network, and supports a maximum data rate of 28 Mbps on a single 6-MHz channel.

Most technologies used in cable broadcasting are used for digital television. Digital television technology makes use of a wireless transmission medium, while cable television broadcasting makes use of a wired transmission medium. Thus, cable broadcasting has an advantage in that it is superior in comparison to terrestrial broadcasting in bi-directional services.

A digital broadcasting receiver, such as a set-top box, for use in digital broadcasting is a device which is mainly directed to deciphering digitized broadcasting and management information transmitted from the head-end, which is installed at a local cable television firm, for the cable television or modem services provided to the subscribers, and transmitting analog signals to televisions. The digital broadcasting receiver receives the broadcasting and management information from the head-end, such as an audio-video server, a service information server for transmitting and receiving broadcasting channel information, or a conditional access server.

A cable digital broadcasting receiver for use in cable digital broadcasting based on the cable network includes, in many cases, a cable modem. The cable modem is a device for converting an analog signal into a digital signal so as to make high-speed Internet available through the cable network. The term “modem” is used because the cable network is an analog network like a telephone network. The telephone network is made up of copper wires, and the cable network is made up of coaxial cables or optical cables. Accordingly, the cable network has a much wider bandwidth than the telephone network. However, the cable network requires modulation and demodulation technology for converting digital into analog, and vice versa, when transmitting data. The cable modem was developed to support the latter capability.

The cable digital broadcasting receiver, including the cable modem, used in cable digital broadcasting is basically composed of a plurality of broadcasting channels and a single modem channel. The broadcasting channel and the modem channel are distinguished by a physical frequency, and it is impossible for them to overlap each other, so that they are exclusive with respect to each other. Information on the broadcasting channels is managed by information called SI (Service information), while information on the modem channel is adapted to find its own channel through a self searching process.

The following patents are considered to be generally pertinent to the present invention, but are burdened by the disadvantages set forth above:

U.S. Pat. No. 6,834,057 to Rabenko et al., entitled CABLE MODEM SYSTEM WITH SAMPLE AND PACKET SYNCHRONIZATION, issued on 21 Dec. 2004, U.S. Pat. No. 6,813,643 to Perlman, entitled MULTIMEDIA SYSTEM WITH SELECTABLE PROTOCOL MODULE INCLUDING MPEG LOGIC AND DOCSIS LOGIC SHARING A SINGLE TUNER, issued on 2 Nov. 2004, U.S. Pat. No. 6,763,032 to Rabenko et al., entitled CABLE MODEM SYSTEM WITH SAMPLE AND PACKET SYNCHRONIZATION, issued on 13 Jul. 10, 2004, U.S. Pat. No. 6,853,680 to Nikolich, entitled SYSTEM AND PROCESS FOR EMBEDDED CABLE MODEM IN A CABLE MODEM TERMINATION SYSTEM TO ENABLE DIAGNOSTICS AND MONITORING, issued on 8 Feb. 2005, U.S. Pat. No. 6,816,500 to Mannette et al., entitled APPARATUS, METHOD AND SYSTEM FOR MULTIMEDIA ACCESS NETWORK CHANNEL MANAGEMENT, issued 9 Nov. 2004, U.S. Pat. No. 6,802,032 to Budinger et al., entitled METHOD AND APPARATUS FOR PERFORMING SYSTEM DIAGNOSTICS ON A CABLE MODEM TERMINATION SYSTEM USING A HAND HELD COMPUTER DEVICE, issued 5 Oct. 2004, U.S. Pat. No. 6,570,913 to Chen, entitled METHOD AND APPARATUS FOR SELECTING OPTIMUM FREQUENCY FOR UPSTREAM DATA TRANSMISSION INA NETWORK SYSTEM UTILIZING CABLE MODEMS, issued 27 May 2003, U.S. Pat. No. 6,490,727 to Nazarathy et al., entitled DISTRIBUTED TERMINATION SYSTEM FOR TWO-DAY HYBRID NETWORKS; issued 3 Dec. 2002, U.S. Pat. No. 6,791,995 to Azenkot et al., entitled MULTICHANNEL, MULTIMODE DOCSIS HEADED RECEIVER, issued 14 Sep. 2004, and U.S. Pat. No. 6,788,707 to Horton, Jr. et al., entitled METHOD FOR THE SUPPRESSION AND EXPANSION OF PACKET HEADER INFORMATION IN CABLE MODEM AND CABLE MODEM TERMINATION SYSTEM DEVICES, issued 7 Sep. 2004.

### SUMMARY OF THE INVENTION

It is, therefore, an objective of the present invention to provide an open cable digital broadcasting system having a multiple DSG channel, and method for acquiring a home DSG channel in the digital broadcasting system, in which a provider of the open cable digital broadcasting receiver constructs the multiple DSG channel to support a service, and provides a method for acquiring the channel of the receiver when the DSG channel is constructed of multiple channels.

According to an aspect of the present invention, there is provided an open cable digital broadcasting system, comprising: at least one Cable Modem Termination System (CMTS) having an upstream band and a downstream band, respectively; a network distributor for transmitting downstream data received from the CMTS to a cable modem corresponding to the downstream band of the downstream data, and for transmitting upstream data received from the cable modem to the CMTS corresponding to the upstream band of the upstream data; and a cable modem for transmitting the upstream data to the network distributor through the upstream band corresponding to upstream data transmission information after identifying upstream data transmission information when receiving the downstream data through the network distributor.

Preferably, the cable modem includes: a DSG channel database; a multiple channel manager for determining whether the channel is a multiple DSG channel or a single DSG channel; and a same channel upstream restoration identifier for performing a downstream channel restoration function when the upstream channel restoration function for the same channel is performed more than a number of times or for more than a term set previously, and for performing an upstream channel restoration function when the upstream channel restoration function for the same channel is not performed more than the number of times or for more than the term set previously.

Preferably, the cable modem performs the upstream channel restoration function within the specific number of times after a specific channel upstream has failed, searches for other downstream channels when the upstream channel restoration function is performed more than the specific number of times, determines whether the channel is a multiple channel or a single channel, performs the upstream channel restoration only when the channel is determined to be a single channel, performs a research stop function in order that the modem does not research a successful channel through a successful channel search process when searching for other downstream channels, and performs a feedback stop function in order that the modem does not return to a DOCSIS operation mode when identifying the channel as a result of another downstream channel search.

According to another aspect of the present invention, there is provided an open cable digital broadcasting system, comprising: a Dynamic Host Configuration Protocol (DHCP) server for assigning a media access protocol (MAP) Internet Protocol (IP) address to a cable modem through a previously assigned media access control (MAC) address; at least one CMTS having an upstream band and a downstream band, respectively; and a cable modem for setting channels of upstream and downstream data, and for transmitting upstream and downstream data to the CMTS when it is determined that the MAP IP address is assigned by the DHCP and that the MAP IP address is assigned.

Preferably, the cable modem includes: a DSG channel database; a multiple channel manager for determining whether the channel is a multiple DSG channel or a signal DSG channel; and a same channel upstream restoration identifier for determining whether the upstream channel restoration function for the same channel is performed more than a number of times set previously.

Preferably, the cable modem performs the following functions: it performs the upstream channel restoration function within the specific number of times after a specific channel upstream is failed; it searches for other downstream channels when the upstream channel restoration function is performed more than the specific number of times; it determines whether the channel is a multiple channel or a single channel, and performs the upstream channel restoration only when the channel is a single channel; it re-searches for a successful channel when searching for the other downstream channel in a searching process; it performs a re-search stop function so that the modem does not re-search a successful channel through a successful channel search process when searching for other downstream channels; and it performs a feedback stop function so that the modem does not return to a DOCSIS operation mode when identifying the channel as a result of an other downstream channel search.

According to yet another aspect of the present invention, there is provided a method for acquiring a home DSG channel in an open cable digital broadcasting receiver, the method comprising: a first step of searching for a downstream channel to a CMTS (cable modem termination system); a second step of determining whether an upstream channel to the CMTS is successful; a third step of converting into a DSG uni-directional downstream mode when the upstream channel search has failed in the second step; a fourth step of determining whether DSG data is received from each server; a fifth step of determining whether the channel is a multiple DSG channel when the DSG data is received in the fourth step; a sixth step of determining whether an upstream channel restoration function for the same channel is performed more than the number of times set previously when the DSG data is determined to be a multiple DSG channel in the fifth step; and a seventh step of performing a downstream channel restoration function when the upstream channel restoration function for the same channel was performed more than the number of times set previously in the sixth step.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a functional block diagram of an open cable digital broadcasting system;

FIG. 2 is a functional block diagram of an open cable digital broadcasting system having a multiple DSG channel in accordance with a first embodiment of the present invention;

FIG. 3 is a functional block diagram of an open cable digital broadcasting system having a multiple DSG channel in accordance with a second embodiment of the present invention;

FIG. 4 is a functional block diagram of an open cable digital broadcasting system having a multiple DSG channel in accordance with a third embodiment of the present invention;

FIG. 5 is a functional block diagram showing a detailed construction of a cable modem of an open cable digital receiver in the open cable digital broadcasting system having the multiple DSG channel shown in FIG. 3 or FIG. 4; and

FIG. 6 is a flow chart showing a method for acquiring a home DSG channel in an open cable digital broadcasting system having a multiple DSG channel in accordance with the present invention.

### DETAILED DESCRIPTION OF THE PREFERRED EMBODIMENTS

Hereinafter, an open cable digital broadcasting system having a multiple DSG channel and method for acquiring a home DSG channel in the digital broadcasting system in accordance with a first embodiment of the present invention will be described with reference to the accompanying drawings in detail.

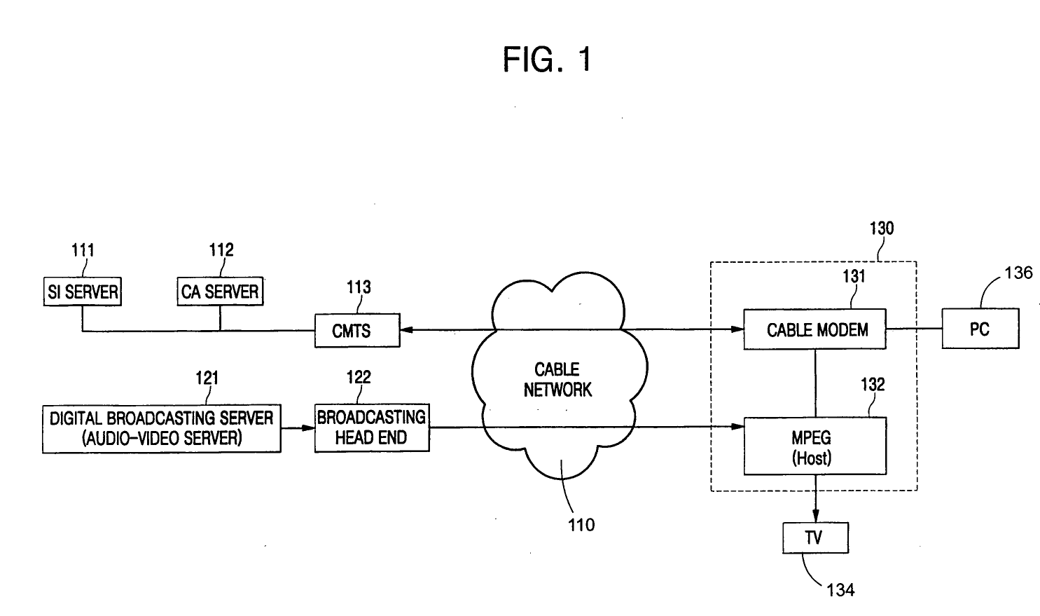

FIG. 1 is a functional block diagram of an open cable digital broadcasting system.

Referring to FIG. 1, the cable digital broadcasting system generally has a structure in which a local cable broadcasting station and a subscriber-side are connected through a cable network 110. A subscriber-side device includes a cable digital broadcasting receiver 130 having a cable modem 131, a television (TV) receiver 134 and a personal computer (PC) 136, while a local cable broadcasting-side device includes a Special Information (SI) server 111 for transmitting broadcasting channel information, a Conditional Access (CA) server 112, a Cable Modem Termination System (CMTS) 113, an audio-video server 121, and a broadcasting head-end 122.

Data transmitted from the local cable broadcasting station to the subscriber-side device include additional information, such as broadcast program information, in addition to video and audio signals, and are transmitted in a unit of packet. The cable digital broadcasting receiver 130 receiving this information processes broadcast signals received from the cable broadcasting station, and converts them into analog signals capable of being recognized by the TV receiver 134.

Hereinafter, the devices located at the local cable broadcasting station will be described first.

Devices related to Internet signals are the CMTS 113, the CA server 112, and the SI server 111, and these devices are interconnected to each other through an Internet Protocol (IP) network.

The CMTS 113 is a cable modem head-end, which is device for converting data of a cable modem 131 into an Internet data packet. The CMTS 113 provides some functions, including a routing function for storing local data in the cable system, a filtering function for protecting a cable operator from undesired hacking, and a traffic embodiment function for guaranteeing a quality of service to the subscriber.

The SI server 111 serves to transmit channel information related to the cable broadcasting, program map information and event information to the subscriber-side, and the CA server 112 controls access to a specific service or content so as to provide access only to an authenticated user.

Meanwhile, the devices associated with the broadcasting signals include the audio-video server 121 and the broadcasting head-end 122.

The audio-video server 121 compresses and digitizes MPEG audio and video signals, and transmits them to a subscriber-side MPEG (Host) 132 through the broadcasting head-end 122.

The broadcasting head-end 122 is a main control center having a technical device for receiving, producing and re-transmitting programs from the audio-video server 121 through the network 110.

The local broadcasting station side, including the above-mentioned devices, communicates with the cable digital broadcasting receiver 130 located in a home using the CMTS 113 and the broadcasting head-end 122 as terminals connected to the network 110.

In the case of communication between the CMTS 113 and the subscriber-side, there is a signal stream from the CMTS 113 to the subscriber-side, and vice versa. In other words, the communication between the CMTS 113 and the subscriber-side is bi-directional.

By contrast, in the case of the broadcasting head-end 122, there is a signal stream from the broadcasting head-end 122 to the subscriber-side, but not the reverse. The broadcasting head-end 122 is characterized by uni-directional communication.

A device required to watch the cable digital broadcasting in the home is the cable digital broadcasting receiver 130.

The cable digital broadcasting receiver 130 is essentially composed of the cable modem 131 and the MPEG (Host) 132.

The cable modem 131 is a device which makes it possible to connect a personal computer (PC) 136 to a cable TV line and to receive data at a maximum data rate of 10 Mbps or so. When the cable modem 131 is installed together with the set-top box, it is possible to watch television. All of the cable modems 131 should be connected to a coaxial cable of a cable television firm in order to communicate with the CMTS 113 of each local cable broadcasting station. Each cable modem 131 can transmit and receive data only with the CMTS 113, and cannot exchange signals with other cable modems connected to the same line. A real bandwidth of the cable TV line for Internet services amounts to maximum of 27 Mbps or so in the downstream direction (from the broadcasting station to the subscriber-side) and 2.5 Mbps or so in the upstream direction (from subscriber-side to the broadcasting station).

The cable modem function of the cable digital broadcasting receiver 130 provides Internet services to the PC 136 of a user by means of connection to the user PC 136, and is used as a return path of a conditional access device which is included in the cable digital broadcasting receiver 130, thereby providing a path for communicating with the CA server 112. When the cable digital broadcasting receiver 130 has a built-in data broadcasting application, it is used as a communication path for bi-directional data broadcasting.

A standard for the cable modem 131 originally involved utilization of a cable television network, which has been already established, to provide the Internet services. The cable network installed by each communication company supports a maximum data speed of 750 MHz, wherein an upstream channel and a downstream channel are used one by one. Further, the frequency band makes use of 6 MHz per channel.

Among them, the upstream signal mainly makes use of a Quadrature Phase Shift Keying (QPSK) scheme, while the downstream signal mainly makes use of a Quadrature Amplitude Modulation (QAM) scheme. The downstream signal may use a maximum of about 30 Mbps in using the 64 QAM scheme widely used at present. The upstream signal may use 10 Mbps in using all of the 6 MHz bandwidth. However, the upstream signal does not use all of the 6 MHz bandwidth, but it uses about 2.4 Mbps due to noise or other various influences. Because of this noise, the upstream channel has a speed slower than the downstream channel. In order to protect the network equipment from the noise generated by devices installed in each home, a QPSK scheme capable of reducing noise a bit more is used. By contrast, the downstream channel uses the QAM scheme because speed is important.

The MPEG (Host) 132 demodulates video and audio data from received MPEG data to allow a video and audio processor (not shown) to process the demodulated data. Broadcast program information, as additional information in the MPEG data, is demodulated and transmitted to a central processing unit (CPU) (not shown).

The overall operation of the cable modem 131 will be described in steps as follows.

First, a frequency of a channel used for downloading is scanned. When powered on, the cable modem 131 automatically searches for the frequency used for uploading and downloading. The frequency is different for each cable modem operator. When the frequency is found, it is locked to the corresponding channel.

After searching and locking the frequency, the cable modem 131 receives data containing contents of the channel used for uploading, i.e., an upstream channel descriptor (UCD), and communicates with an external network using this information. If the cable modem 131 fails to receive the UCD, it attempts upstream channel restoration after setting a DSG unidirectional mode.

Next, the cable modem 131 checks intensity (referred to as “level”) at which a signal is transmitted on uploading. When setting of the channels used for uploading and downloading is completely terminated, the cable modem 131 obtains access to a DHCP (Dynamic Host Configuration Protocol) server (not shown), and is assigned an IP (Internet protocol) address and a gateway address. The cable modem 131 reserves the assigned addresses, and then transmits them to a LAN (local area network) card of the PC 136.

The cable modem 131 assigned the IP address is supplied, from a server, with a ‘configuration file’ which contains various information required for operation in addition to frequency information. At this time, the cable modem 131 uses a protocol known as Trivial File Transfer Protocol (TFTP). The configuration file is different according to the cable modem. Cable modem operators can restrict uploading and downloading speeds by using the configuration file.

The DHCP server leases the IP address to the cable modem 131 for a preset time period (e.g., 24 hours, 12 hours, 1 hour, etc.). When the cable modem 131 is still being used after the preset time has elapsed, the cable modem 131 is allowed to continue to use the leased IP address. In order to calculate this time, the cable modem 131 is supplied with a current time from a server. Here, the server is the DHCP server for the most part. When the IP address is not assigned by the DHCP server, the cable modem 131 attempts a DSG uni-directional mode.

With the series of processes mentioned above, an environment wherein users can normally use the Internet is provided.

On reviewing upstream and downstream channel searches in the cable digital broadcasting receiver 121 of such an open cable digital broadcasting system, the cable modem 131 searches for the downstream channel with the CMTS 113 first.

Next, the cable modem 131 performs an upstream channel restoration function.

The upstream channel restoration function is to determine whether the UCD is acquired, the initial Ranging and DHCP-provided IP address are acquired, the TFTP is successful, and the CMTS 113 is registered.

At this time, if the cable modem 131 failed to restore the upstream channel, it proceeds into the DSG uni-directional downstream mode.

Subsequently, the cable modem 131 performing the DSG uni-directional downstream mode again searches for the upstream channel when it receives the DSG data from the SI server 111, and the cable modem 131 searches for other downstream channels when it does not receive the DSG data.

However, the cable modem 131 is used in a single DSG channel, and searches for the channel regardless of an environment of the cable modem 131 since it has a function for searching for the finally successful channel again, and it can search for a single DSG channel but cannot search for a multiple DSG channel.

Also, since the DSG channel cannot escape from the channel due to the upstream restoration function, even though the first DSG channel is not its own channel in the case a plurality of multiple DSG channels, it is not possible to identify its own DSG channel.

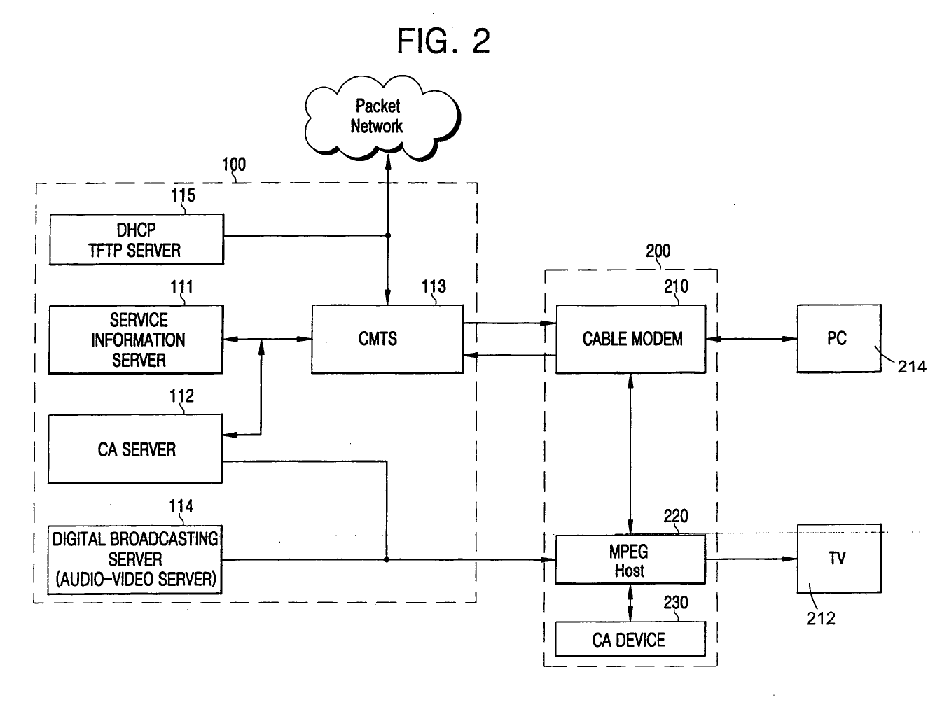

FIG. 2 is a functional block diagram of an open cable digital broadcasting system having a multiple DSG channel in accordance with a first embodiment of the present invention.

Referring to FIG. 2, the open cable digital broadcasting system has a configuration in which a local cable broadcasting station 100 and a subscriber-side cable digital broadcasting receiver 200 are connected to each other. The subscriber-side cable digital broadcasting receiver 200 includes a cable modem 210, an MPEG (Host) 220 and a conditional access (CA) server 230, and is connected to a TV receiver 212 and a PC 214. The local cable broadcasting station 100 includes a service information server 111 for transmitting broadcasting channel information, a conditional access (CA) server 112, at least one Cable Modem Termination System (CMTS) 113, a digital broadcasting server or audio-video server 114, a DHCP/TFTP server 115, and the like.

Data transmitted from the local cable broadcasting station 100 to the subscriber-side cable digital broadcasting receiver 200 include additional information, such as broadcast program information, as well as the audio and video signals, and are transmitted in a unit of a packet. The cable digital broadcasting receiver 200 receiving such information processes the broadcast signal received from the cable broadcasting station 100, and converts the broadcast signal into an analog signal that can be recognized by the TV receiver 212.

First, the devices in the local cable broadcasting station 100 will be explained.

Devices related to Internet signals include the service information server 111, the conditional access server 112, and the CMTS 113, and these devices are connected to each other through an Internet Protocol (IP) network.

The CMTS 113 is the head-end of cable modem 210, and is a device for converting data for cable modem 210 into an Internet data packet. The CMTS 113 provides several functions, including a routing function for storing local data in the cable system, a filtering function for protecting cable operators from undesired hacking, and a traffic embodiment function for guaranteeing a quality of service to the subscriber.

The service information server 111 serves to transmit channel information relating to cable broadcast, a program map and event information to the subscriber-side, and the conditional access server 112 performs the function of permitting access to a specific service or contents to only an authorized person.

Meanwhile, devices related to the broadcast signal include the digital broadcasting server or audio-video server 114 and a broadcasting head-end (not shown).

The audio-video server 114 compresses and digitizes MPEG audio/video signals, and transmits the digitized signals to the MPEG (Host) 220 of the subscriber-side through the broadcasting head-end (not shown).

The term “broadcasting head-end” refers to a main control center having a technical device that receives programs from the audio-video server 114 through a network, and produces and retransmits the programs.

The local broadcasting station side constructed of the components described above communicates with the cable digital broadcasting receiver 200 located in a home using the CMTS 113 and the broadcasting head-end (not shown) as terminal points that are connected to the network.

In the case of communication between the CMTS 113 and the subscriber-side, there is a signal stream from the CMTS 113 to the subscriber-side, and vice versa. In other words, the communication between the CMTS 113 and the subscriber-side is bi-directional.

By contrast, in the case of the broadcasting head-end, there is a signal stream from the broadcasting head-end to the subscriber-side, but not in reverse. The broadcasting head-end is characterized by uni-directional communication.

The cable digital broadcasting receiver 200 is needed to watch a cable digital broadcast in the home.

The cable digital broadcasting receiver 200 is essentially composed of the cable modem 210, the MPEG (Host) 220, and the CA device 230.

The cable modem 210 is a device that connects the personal computer (PC) 214 to a cable TV line, and enables data to be received at a maximum data rate of 10 Mbps or so. If the cable modem 210 is installed together with the set-top box, it is also possible to watch TV. All cable modems 210 should be connected to a coaxial cable of the cable TV company in order to communicate with the CMTS 113 in each cable broadcasting station 100. All cable modems 210 can exchange data with the CMTS 113 only, and cannot exchange signals with other cable modems 210 connected to the same line. The real bandwidth of the cable TV line for Internet service amounts to maximum of 27 Mbps or so in the downstream direction (from broadcasting station to the subscriber-side), and a maximum of 2.5 Mbps or so in the upstream direction (from the subscriber-side to the broadcasting station).

The cable modem 210 of the cable digital broadcasting receiver 200 enables the PC 214 to use the Internet service when the modem 210 is connected to the user PC (Personal Computer) 214, and is used as a return path of the conditional access (CA) device 230 included in the cable digital broadcasting receiver 200 so that it is used as a communication path with the conditional access (CA) server 112. When a data broadcasting application is embedded in the digital broadcasting receiver 200, the cable modem 210 is used as a communication path for bi-directional data broadcasting.

A standard for the cable modem 210 involves utilization of a cable television network, which has been already established, to provide Internet services. The cable network installed by each communication company supports a maximum of 750 MHz, wherein an upstream channel and a downstream channel are used one by one. Further, the frequency band makes use of 6 MHz per channel.

Among them, the upstream signal mainly makes use of a Quadrature Phase Shift Keying (QPSK) scheme, while the downstream signal mainly makes use of a Quadrature Amplitude Modulation (QAM) scheme. The downstream signal may use a maximum of about 1-30 Mbps in using the 64 QAM scheme widely used at present. The upstream signal may use 10 Mbps in using all of the 6 MHz bandwidth. However, the upstream signal does not use all of the 6 MHz bandwidth, but it uses about 2.4 Mbps due to noise or various other influences. Because of this noise, the upstream channel has a speed slower than the downstream channel in the cable modem 210. In order to protect the network equipment from the noise generated by devices installed in each home, the QPSK scheme which is capable of reducing the noise a bit more in any way is used. By contrast, the downstream channel uses the QAM scheme because speed is important.

The MPEG (Host) 220 demodulates video and audio data from received MPEG data to allow a video and audio processor (not shown) to process the demodulated data, wherein broadcast program information, contained as additional information in the MPEG data, is demodulated and transmitted to a central processing unit (CPU) (not shown).

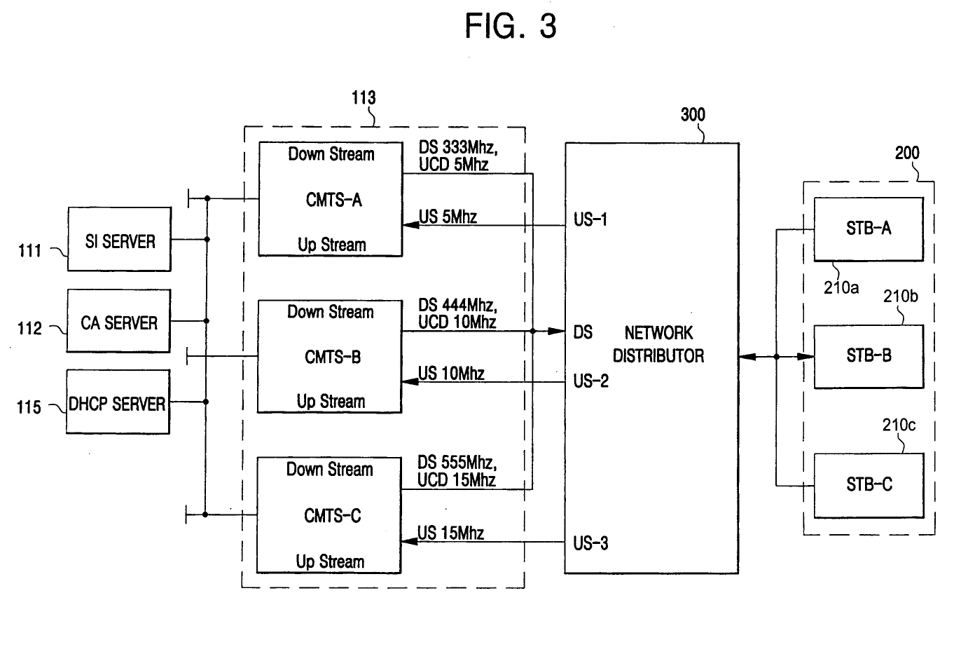

FIG. 3 is a functional block diagram of an open cable digital broadcasting system having a multiple DSG channel in accordance with a second embodiment of the present invention.

Referring to FIG. 3, the open cable digital broadcasting system having the multiple DSG channel in accordance with the second embodiment of the present invention includes at least one CMTS 113, at least one cable modem 200 and a network distributor 300.

Each CMTS 113 (CMTS-A, CMTS-B and CMTS-C) has upstream and downstream bands, and serves to transmit data to and receive data from the cable modems 210a, 210b and 210c (STB-A, STB-B and STB-C) through the bands.

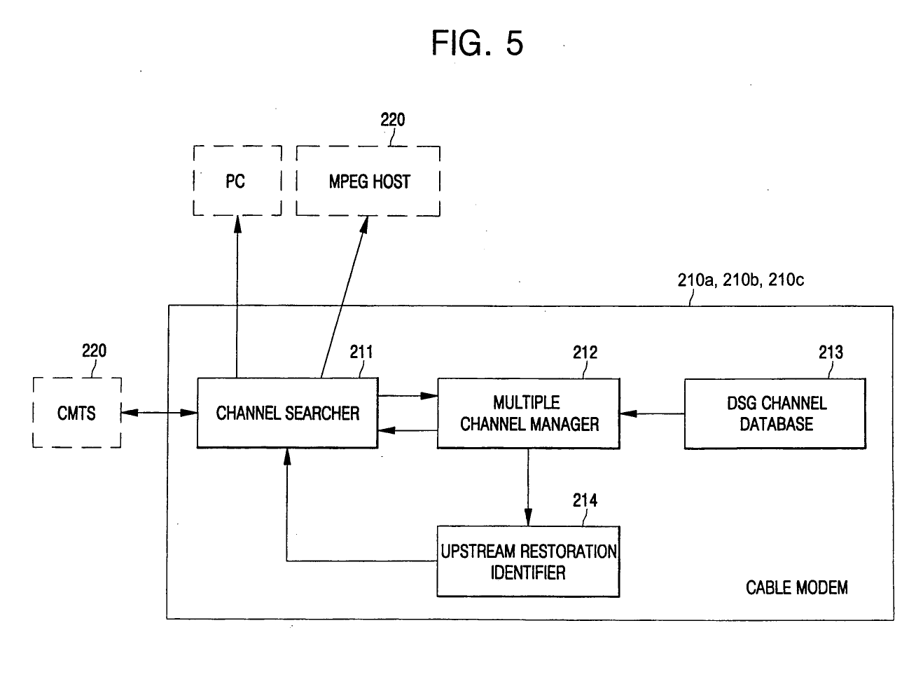

When the cable modems 200 receive the downstream data through the network distributor 300, they identify the upstream data transmission information from the downstream data and transmit the upstream data to the network distributor 300 through an upstream band corresponding to the upstream data transmission information. Each cable modem 210a, 210b and 210c includes a channel searcher 211, a multiple channel manager 212, a DSG channel database 213, and an upstream restoration identifier 214, as shown in FIG. 5.

While the channel searcher 211 has to search for a modem channel, the channel search process first generally passes through searches of high and low speed modes for an Harmonic Related Carrier (HRC) band, and searches of high and low speed modes for an Incremental Related Carrier (IRC) band. In addition, the channel search may sequentially progress from a low frequency to a high frequency in an assigned frequency band, or may progress as it is skipped in a unit of several channels. Of course, it should be considered that the search direction can be reversed. For example, it is assumed that the frequency band of a total of 127 channels from 93 MHz to 855 MHz is assigned to the corresponding local cable broadcasting station 100. Assuming that 645 MHz is assigned to the modem channel, and 155 MHz for channel 1, 161 MHz for channel 2, . . . , and 699 MHz for channel 50 are assigned in the case of the broadcast channels, the number of channels for which the cable modem channel search device has to search by the existing search method is a total of 127 channels, including the broadcast channels and the modem channels.

If the multiple channel manager 212 fails to perform the upstream channel search from the channel searcher 211, it proceeds into the DSG unidirectional downstream mode. When the multiple channel manager 212 receives the service information and the DSG data from the conditional access server 112, it determines whether the channel is a multiple DSG channel or a single DSG channel through the DSG channel database 213.

The upstream restoration identifier 214 serves to perform an upstream cannel restoration function for an arbitrary number of times or for a certain period of time when the DSG data is identified as the multiple DSG channel.

The network distributor 300 serves to transmit the DSG data to the cable modem 210 corresponding to the downstream band of the downstream data received from the CMTS 113, and to the CMTS 113 corresponding to the upstream band of the upstream data received from the cable modem 210.

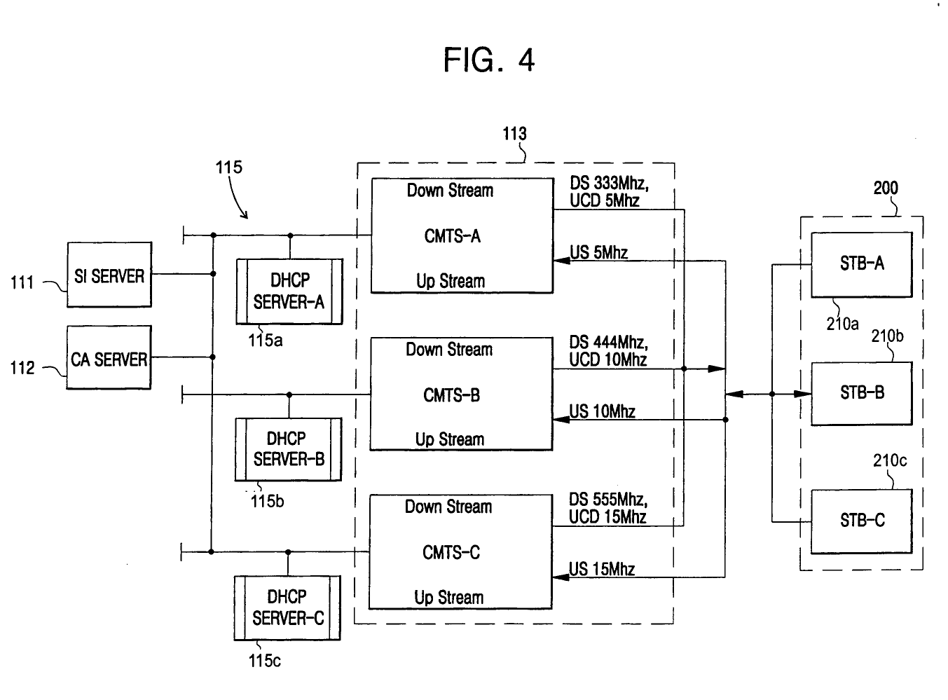

FIG. 4 is a functional block diagram of an open cable digital broadcasting system having a multiple DSG channel in accordance with a third embodiment of the present invention.

Referring to FIG. 4, the open cable digital broadcasting system having the multiple DSG channel in accordance with the third embodiment of the present invention includes at least one CMTS 113, at least one DHCP server 115, and at least one cable modem 200.

Each CMTS 113 (CMTS-A, CMTS-B, CMTS-C) has upstream and downstream bands, and serves to transmit data to and receive data from the cable modems 210a, 210b, 210c (STB-A, STB-B, STB-C) through the upstream and downstream bands.

Each DHCP server 115a, 115b, 115c serves to assign to the cable modem 210a, 210b, 210c an MAP IP address through a MAC address assigned previously.

If the cable modem 210a, 210b, 210c is assigned the MAP IP address as a result of a determination as to whether the MAP IP address is assigned by the DHCP server 115, it sets the channels of the upstream and downstream data and serves to transmit the upstream and downstream data to the CMTS 113. Each cable modem 210a, 210b, 210c includes a channel searcher 211, a multiple channel manager 212, a DSG channel database 213, and an upstream restoration identifier 214, as shown in FIG. 5.

FIG. 5 is a functional block diagram showing a detailed construction of a cable modem of an open cable digital receiver in the open cable digital broadcasting system having the multiple DSG channel shown in FIG. 3 or FIG. 4.

Referring to FIG. 5, while the channel searcher 211 has to search for a modem channel, the channel search process first generally passes through searches of high and low speed modes for an Harmonic Related Carrier (HRC) band, and searches of high and low speed modes for an Incremental Related Carrier (IRC) band. In addition, the channel search may sequentially progress from a low frequency to a high frequency in an assigned frequency band, or may progress as it is skipped in a unit of several channels. Of course, it should be considered that the search direction can be reversed. For example, it is assumed that the frequency band of a total of 127 channels from 93 MHz to 855 MHz is assigned to the corresponding local cable broadcasting station 100. Assuming that 645 MHz is assigned to the modem channel, and 155 MHz for channel 1, 161 MHz for channel 2, . . . , and 699 MHz for channel 50 are assigned in the case of the broadcast channels, the number of channels for which the cable modem channel search device has to search by the existing search method is a total of 127 channels, including the broadcast channels and the modem channels.

If the multiple channel manager 212 fails to perform the upstream channel search from the channel searcher 211, it proceeds into the DSG uni-directional downstream mode. When the multiple channel manager 212 receives the service information and the DSG data from the conditional access server 112, it determines whether the channel is a multiple DSG channel or a single DSG channel through the DSG channel database 213.

The upstream restoration identifier 214 serves to perform an upstream cannel restoration function for an arbitrary number of times or for a certain period of time when the DSG data is identified as the multiple DSG channel through the multiple channel manager 212.

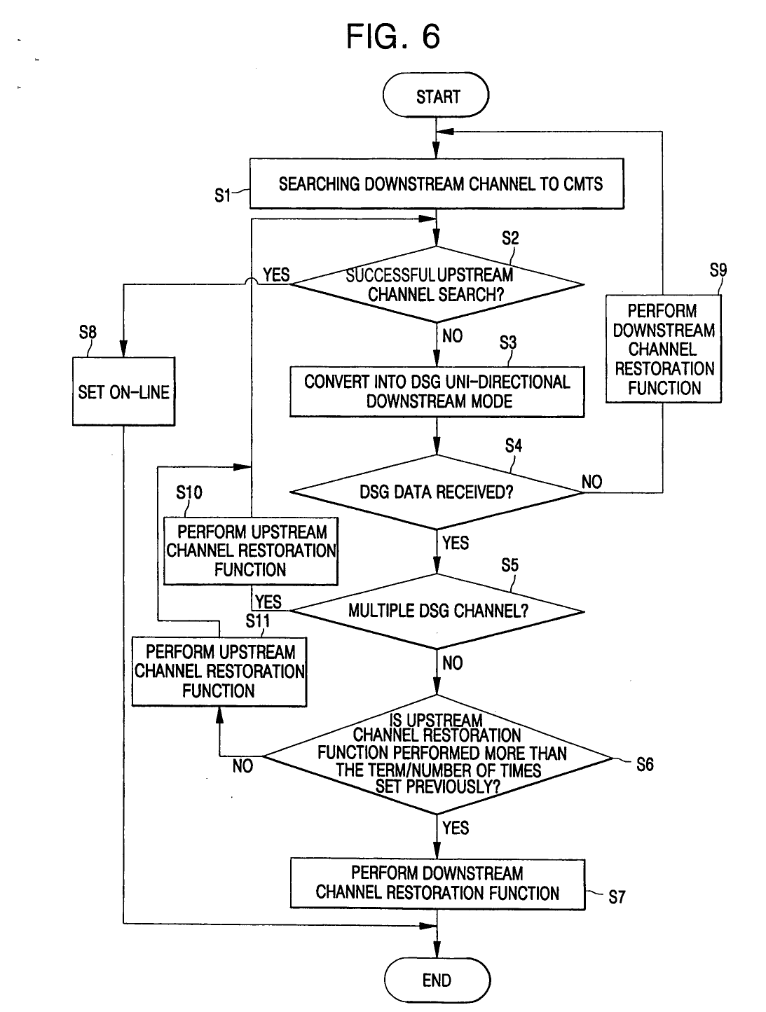

A method for acquiring a home DSG channel in the open cable digital broadcasting system having a multiple DSG channel constructed as described above will now be described with reference to FIG. 6.

FIG. 6 is a flow chart showing a method for acquiring a home DSG channel in an open cable digital broadcasting system having a multiple DSG channel in accordance with the present invention.

Referring to FIGS. 2 thru 4 and 6, the cable modem 210 first searches for the downstream channel to the CMTS 113 (S1).

Subsequently, the cable modem 210 determines whether the search of the upstream channel to the CMTS 113 is successful (S2).

At this time, if the search of the upstream channel fails in the second step (S2), the cable modem 210 is converted into the DSG uni-directional downstream mode (S3).

Then, the cable modem 210 determines whether the DSG data is received from each server through the CMTS 113 (S4).

At this time, if it is determined that the DSG data is received in the fourth step (S4), the cable modem 210 determines whether the DSG data is the multiple DSG channel through the multiple channel manager 212 (S5).

If the DSG data is determined to be the multiple DSG channel in the fifth step (S5), the cable modem 210 determines whether the upstream channel restoration function for the same channel is performed more than the number of times or for more than the term set previously (S6).

At this time, if the upstream channel restoration function for the same channel is performed more than the number of times or for more than the term set previously in the sixth step (S6), the cable modem 210 performs the downstream channel restoration function (S7). In addition, the seventh step (S7) includes the step of stopping the successful channel research function, and the step of stopping the DOCSIS feedback mode function.

Conversely, if the upstream channel search succeeded in the second step (S2), the cable modem 210 is set online.

Meanwhile, if the DSG data is not received in the fourth step (S4), the cable modem 210 performs the downstream channel restoration function (S9).

If the DSG data is determined to be the single DSG channel in the fifth step (S5), the cable modem 210 performs the upstream channel restoration function (S6) again.

Conversely, if the upstream channel restoration function for the same channel is not performed more than the number of times or for more than the term set previously in the sixth step (S6), the cable modem 210 performs the upstream channel restoration function (S11).

As described above, according to the open cable digital broadcasting system having the multiple DSG channel and the method for acquiring a home DSG channel in the digital broadcasting system in accordance with the present invention, there is an excellent advantage in that it is possible to search for a multiple DSG channel and to satisfy a provider service model request condition of the open cable digital broadcasting receiver.

While the present invention has been described with reference to exemplary embodiments thereof, it will be understood by those skilled in the art that various changes in form and detail may be made therein without departing from the scope of the present invention as defined by the following claims.

What is claimed is:

1. A method for acquiring a home data over cable service interface specifications set-top box gateway (DSG) channel in an open cable digital broadcasting receiver, comprising the steps of:
(a) while searching for upstream and downstream channels to a cable modem termination system (CMTS), converting a channel into a DSG uni-directional downstream mode when the upstream channel search fails, and determining whether DSG data is received from all servers;
(b) determining whether the channel is a multiple DSG channel when the DSG data is received in step (a); and
(c) trying an upstream channel restoration function when the channel is the multiple DSG channel, and performing a downstream channel restoration function when the upstream channel restoration function fails.

2. The method according to claim 1, further comprising the step of performing the upstream channel restoration function when the channel is determined to be a single DSG channel in step (b).

3. The method according to claim 1, further comprising the steps of:
determining whether the upstream channel restoration function for the same channel is performed more than a preset number of times when the DSG data is received and the channel is determined to be the multiple DSG channel; and
performing the downstream channel restoration function when the upstream channel restoration function for the same channel is performed more than the preset number of times.

4. The method according to claim 3, further comprising the step of performing the upstream cannel restoration function when the upstream channel restoration function for the same channel is not performed more than the preset number of times.

5. A method for acquiring a home data over cable service interface specifications set-top box gateway (DSG) channel in an open cable digital broadcasting receiver, comprising:
a first step of searching for a downstream channel to a cable modem termination system (CMTS);
a second step of determining whether an upstream channel to the CMTS is successful;
a third step of converting to a DSG uni-directional downstream mode when the upstream channel search fails in the second step;
a fourth step of determining whether DSG data is received from all servers;
a fifth step of determining whether the channel is a multiple DSG channel when the DSG data is received in the fourth step;
a sixth step of determining whether an upstream channel restoration function for the same channel is performed to more than a preset maximum extent when the channel is determined to be the multiple DSG channel in the fifth step; and
a seventh step of performing a downstream channel restoration function when the upstream channel restoration function for the same channel is performed to more than the preset maximum extent in the sixth step.

6. The method according to claim 5, further comprising an eighth step of setting to an on-line state wherein a bi-directional communication is available when the upstream channel search to the CMTS is successful in the second step.

7. The method according to claim 5, further comprising an eighth step of performing the downstream channel restoration function when the DSG data is not received in the fourth step.

8. The method according to claim 5, further comprising an eighth step of performing the upstream channel restoration function when the DSG data is determined to be a single DSG channel in the fifth step.

9. The method according to claim 5, further comprising an eighth step of performing the upstream channel restoration function when the upstream channel restoration function for the same channel was not performed to more than the preset maximum extent as determined in the sixth step.

10. The method according to claim 5, wherein the seventh step includes a step of stopping a successful channel research function.

11. The method according to claim 5, wherein the sixth step includes a step of stopping a data over cable service interface specifications (DOCSIS) feedback mode function.

12. An open cable digital broadcasting system, comprising:
at least one cable modem termination system (CMTS) having an upstream band and a downstream band;
a network distributor for transmitting downstream data received from the CMTS to a cable modem in correspondence to the downstream band, and for transmitting upstream data received from the cable modem to the CMTS in correspondence to the upstream band; and
a cable modem for transmitting the upstream data to the network distributor through the upstream band in correspondence to upstream data transmission information after identifying the upstream data transmission information from the downstream data when receiving the downstream data through the network distributor.

13. The system according to claim 12, wherein the cable modem includes:
a channel searcher for searching for an upstream channel and a downstream channel;
a data over cable service interface specifications set-top box gateway (DSG) channel database; and
a multiple channel manager for determining whether the channel is a multiple DSG channel or a single DSG channel through the DSG channel database.

14. The system according to claim 12, wherein the cable modem includes a same channel upstream restoration identifier for performing a downstream channel restoration function when an upstream channel restoration function for a same channel is performed to more than a preset maximum extent, and for performing an upstream channel restoration function when the upstream channel restoration function for the same channel is not performed to more than the preset maximum extent.

15. The system according to claim 12, wherein the cable modem performs an upstream channel restoration function within a specific number of times after a specific channel upstream is a failure, and searches for other downstream channels when the upstream channel restoration function is performed more than the specific number of times.

16. The system according to claim 12, wherein the cable modem performs a re-search stop function so that the modem does not re-search a successful channel through a successful channel search process when searching for other downstream channels.

17. The system according to claim 12, wherein the cable modem performs a feedback stop function so that the modem does not return to a data over cable service interface specifications (DOCSIS) operation mode when identifying the channel as a result of another downstream channel search.

18. An open cable digital broadcasting system, comprising:
a dynamic host configuration protocol (DHCP) server for assigning a media access protocol (MAP) Internet protocol (IP) address to a cable modem through a previously assigned media access control (MAC) address;
at least one cable modem termination system (CMTS) having an upstream band and a downstream band; and
a cable modem for setting channels of upstream and downstream data, and for transmitting upstream and downstream data to the CMTS when it is determined that the MAP IP address is assigned by the DHCP and that the MAP IP address is assigned.

19. The system according to claim 18, wherein the cable modem includes:
a channel searcher for searching for an upstream channel and a downstream channel;
a data over cable service interface specifications set-top box gateway DSG channel database; and
a multiple channel manager for determining whether the channel is one of a multiple DSG channel and a signal DSG channel through the DSG channel database.

20. The system according to claim 18, wherein the cable modem includes a same channel upstream restoration identifier for determining whether the upstream channel restoration function for the same channel is performed to more than a preset maximum extent.

21. The system according to claim 18, wherein the cable modem performs an upstream channel restoration function within a specific number of times after a specific channel upstream fails, and searches for other downstream channels when the upstream channel restoration function is performed more than the specific number of times.

22. The system according to claim 18, wherein the cable modem determines whether the channel is one of a multiple channel and a single channel, and performs only the upstream channel restoration function when the channel is the single channel.

23. The system according to claim 18, wherein the cable modem re-searches for a successful channel when searching for other downstream channels in a searching process.

27. The system according to claim 18, wherein the cable modem performs a re-search stop function so that the modem does not re-search a successful channel through a successful channel search process when searching for other downstream channels.

25. The system according to claim 18, wherein the cable modem performs a feedback stop function so that the modem does not return to a data over cable service interface specifications (DOCSIS) operation mode when identifying a channel as a result of another downstream channel search.
